(19) United States
(12) Patent Application Publication
(10) Pub. No.: US 2003/0135290 A1
(43) Pub. Date: Jul. 17, 2003

(54) Vehicle road wheel fuzzy logic control system and method of implementing a fuzzy logic strategy for same

(76) Inventors: Yixin Yao, Ann Arbor, MI (US); Gregory James Stout, Ann Arbor, MI (US)

Correspondence Address: ZACHARY HAMILTON, Brinks Hofer Gilson & Lione, TBC Tower - Suite 3600, 455 N. Cityfront Plaza Drive, Chicago, IL, 60611, US

(21) Appl. No.: 10/037,059

(22) Filed: Dec. 31, 2001

(51) Int. Cl. G06F 15/18; G05B 13/02

(52) U.S. Cl. 700/50; 700/51

(57) ABSTRACT

A road wheel fuzzy logic control system, including a fuzzy logic control unit having, a plurality of inputs signals, and generating a control output signal, and a road wheel subsystem that receives the control output signal and generates an output feedback signal to the fuzzy logic control unit, wherein the fuzzy logic control tracks an input signal under the effects of uncertainties and disturbances from the road wheel subsystem and vehicle dynamics. The fuzzy logic control unit controls the effects of the uncertainty and disturbance and provides vehicle stability.

### FIELD OF INVENTION

The present invention relates generally to a steering system for a vehicle and more particularly to a road wheel fuzzy logic control system.

### DISCUSSION OF RELATED ART

FIG. 1 shows a schematic diagram of a known road wheel control system 100. The road wheel control system 100 includes two road wheels 101, two tie rods 102, a road wheel actuator 103 and its amplifier 104, a road wheel angle sensor 106, and a road wheel controller 107. A reference angle input signal 108 to the road wheel controller 107 comes from the road wheel angle input device 105. In operation, the road wheel angle input device 105 may be an actuator-based steering control system, force feedback joystick or any device with the function to provide a reference input angle 108 to the road wheel control system 100 and the steering feel for the driver at the same time, such as, U.S. Patent Ser. No. ______ entitled Steering Control With Variable Damper Assistance And Method Implementing The Same, Brinks, Hofer, Gilson & Lione docket number 10541-118, Visteon Corp. docket number V200-0324 and filed concurrently with the present invention the entire contents of each of which is incorporated herein. The road wheel control system 100 and its angle input device (steering wheel control system) 105 include a so-called well known steer-by-wire control system. In a steer-by-wire system, the mechanical linkage between steering wheel and road wheels has been eliminated. The steering wheel angle command signal (designated as driver input) is translated to a road wheel angle by using electric analog or digital signals.

Certain vehicle dynamics signals 109, such as, the vehicle speed, yaw rate and lateral acceleration are also fed to the road wheel controller 107 via vehicle dynamics sensor 111. The road wheel controller 107 uses control algorithms to generate control signals that are converted by actuator power electronics 104 to actuator drive signals which are sent to the road wheel actuator 103 and transmitted by the tie rod 102 to the road wheels 101 based on the received signals. A road wheel angle signal 113 is generated by the road wheel angle sensor 106 in response to the road wheel actuator 103 and sent to the road wheel controller 107. An equivalent rack load torque 112 from the vehicle dynamics is applied to the road wheel system 100 due to forces between the road and road wheels 101.

One major problem for the control of a steer-by-wire road wheel system described above is that the dynamics of the road wheel control system change with the changing dynamics of the vehicle. The vehicle dynamics change with road conditions, vehicle loads, and external circumstances. These changing vehicle dynamics present the road wheel control system with severe uncertainties.

Another design problem with the above described vehicle and road wheel system of a road vehicle is that severe nonlinear characteristics exist. It is very difficult to obtain linearly parameterizeable dynamics due to complicated vehicle dynamics, severe nonlinearity and time-variance of the vehicle system. Therefore, severe uncertainties and nonlinear characteristics in the road wheel control system 100 pose difficulties for the road wheel system modeling and control.

### BRIEF SUMMARY OF THE INVENTION

One aspect of the present invention is to provide a road wheel fuzzy logic control system for an automotive vehicle. The road wheel fuzzy logic control system has a fuzzy logic control unit. The fuzzy logic control unit receives a plurality of input signals, and generates a control output signal. The road wheel fuzzy logic control system also has a road wheel subsystem that receives the control output signal and generates an output feedback signal to the fuzzy logic control unit. The fuzzy logic control unit tracks an input signal I under the effects of uncertainty and disturbance from the road wheel subsystem and vehicle dynamics and controls the effects of the uncertainty and disturbance and provides vehicle stability control.

Another aspect of the present invention is to provide a method of implementing a fuzzy logic strategy for a fuzzy logic control system used in a road wheel control system. This is accomplished by a generating linguistic variable from a numerical input variable of a road wheel system, generating hypothesis based on the linguistic variable and a fuzzy rule, and generating a numerical output variable from the hypothesis to control the road wheel system and generating the numerical input variable by applying the numerical output value to a road wheel and a vehicle dynamic signal.

Each aspect of the present invention provides the advantages of:

1. System robustness in the face of uncertainties. The road wheel system exhibits robust stability under the effects of the vehicle dynamics, road conditions, vehicle loads, and other uncertainties;

2. A solution for the vehicle dynamic nonlinear characteristics. The stability and performance requirements can be satisfied even though the vehicle dynamics exhibit severe nonlinear characteristics that affect the road wheel control system;

3. Optimal control performance. The system performance, such as the rapid and accurate response to steering commands, the minimum static error during exposure to certain external disturbances, accurate dynamic tracking error, and smooth response with no overshoot, are improved;

4. No requirement for the controlled plant mathematic model. Because there is no need for an explicit mathematic model of the road wheel controlled plant to design a fuzzy logic controller, the design process can be extremely simple. The design methods using fuzzy logic allow the designer to obtain a satisfactory controller with minimum effort. The control system design period and cost are reduced as a result; and

5. Wide application range. It is known that production variation exists in the same type of components, such as differing electrical characteristics of individual DC motors due to quality dispersion and aging. The fuzzy logic controller has the adaptive ability for this type of variation, meaning that the controller does not need to be individually adjusted to satisfy the system specifications.

Additional embodiments and advantages of the present invention will become apparent from the following description and the appended claims when considered with the accompanying drawing.

### BRIEF DESCRIPTION OF THE DRAWINGS

FIG. 1 shows a schematic diagram of an embodiment of a known road wheel control system.

FIG. 2 shows a block diagram of an embodiment of a road wheel control system according to the present invention.

FIG. 3A schematically shows an embodiment of a road wheel servo control to be used with the road wheel control system of FIG. 2.

FIG. 3B schematically shows an embodiment of a vehicle stability control to be used with the road wheel control system of FIG. 2.

FIG. 4 shows a flowchart for an embodiment of a road wheel fuzzy logic control system to be used with the road wheel control system of FIG. 2.

FIG. 5 shows an embodiment of triangular-shaped membership functions to be used for the road wheel control system of FIG. 2.

FIGS. 6A-B show graphs of the fuzzification process for the variables road wheel error and error change, in accordance with the present invention.

FIG. 7 shows an example of using the AND operation rule in the inference process in accordance with the present invention.

FIG. 8 shows an example of fuzzy logic results being combined in the inference process in accordance with the present invention.

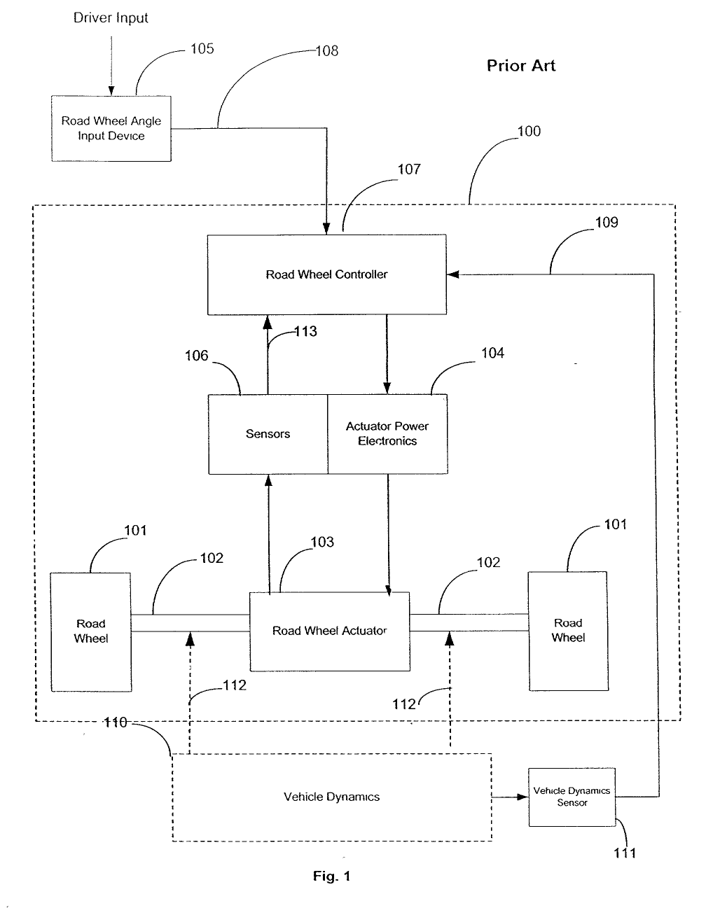

### DETAILED DESCRIPTION OF THE INVENTION

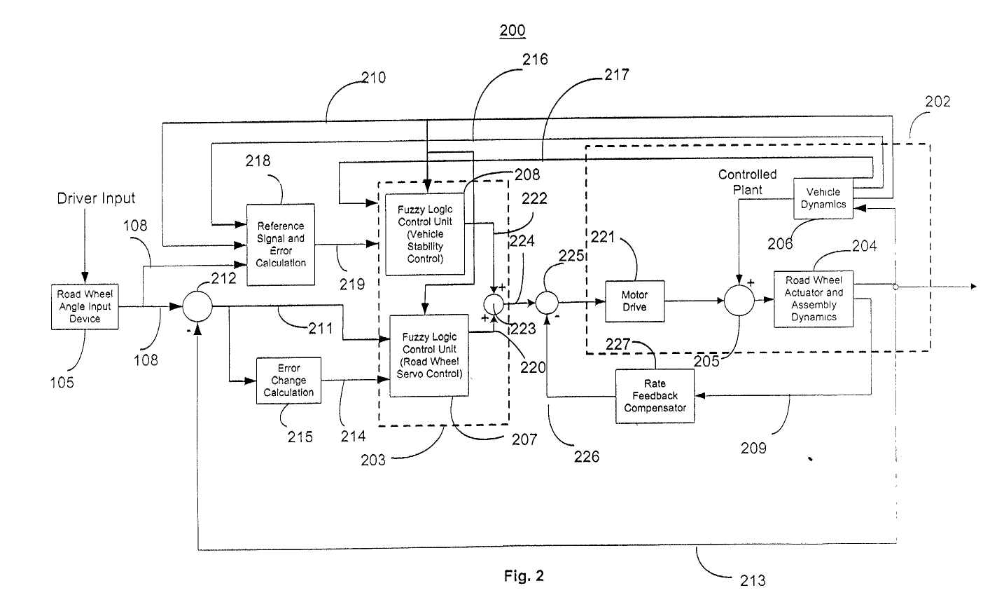

FIG. 2 shows a block diagram of a road wheel fuzzy logic control system 200. The road wheel fuzzy logic control system 200 includes a controlled plant 202 and a fuzzy logic control unit 203. The controlled plant 202 includes actuator-based road wheel dynamics 204, a motor drive gain 205 and vehicle dynamics 206. The fuzzy logic control unit 203 includes two parts: a road wheel servo tracking controller 207 and a vehicle stability controller 208. The objective of the road wheel servo controller 207 is to track a road wheel angle reference signal (θᵣₛ(k)) 108 under the effects of uncertainty and disturbance from the controlled road wheel system and vehicle 100, as described previously. The objective of the vehicle stability controller 208 is to overcome the effect of vehicle uncertainties and accomplish the vehicle dynamics stabilizing control function.

The relative signals processed by the road wheel servo controller 207 include the road wheel angle reference signal (θᵣₛ(k)) 108 (the steering wheel angle times the steering ratio), the road wheel angle signal (θᵣ(k)) 213 (as the feedback signal), the vehicle speed signal (v(k)) 210, the road wheel angle error signal (e(k)) 211 and the road wheel angle error change signal (Δe(k)) 214. The road wheel angle error signal (e(k)) 211 comes from the summing junction 212 that subtracts the road wheel angle signal (θᵣ(k)) 213 from the road wheel angle reference signal (θᵣ(k)) 108. The road wheel angle error change signal (Δe(k)) 214 comes from the angle error change calculation block 215, where Δe(k)=e(k)−e(k−1) every sampling time. The variable k is an index variable that refers to a discrete point in time (k=1, 2, 3, . . . etc).

The relative signals processed by the vehicle stability controller 208 include the road wheel angle reference signal (θᵣₛ(k)) 108, lateral acceleration signal (aᵥ(k)) 216, yaw rate (r(k)) 217, and vehicle speed signal (v(k)) 210. The acceleration error signal calculation block 218 provides the lateral acceleration error signal (eₐ(k)) 219, which is the difference between the lateral acceleration reference signal (not shown) and the measured lateral acceleration signal (as feedback signal) 216. The lateral acceleration reference signal can be produced from the different strategies using, for example, the road wheel angle (θᵣ(k)) 108 and vehicle speed (v(k)) 210 signals.

In a preferred embodiment, the acceleration error signal calculator block 218 receives the road wheel angle reference signal (θᵣₛ(k)) 108, the vehicle speed signal (v(k)) 210 and the lateral acceleration signal (aᵥ(k)) 216, and generates the acceleration error signal (eₐ(k)) 219. The vehicle stability controller 208 receives as inputs the acceleration error signal (eₐ(k)) 219, yaw rate signal (r(k)) 217, and vehicle speed signal (v(k)) 210.

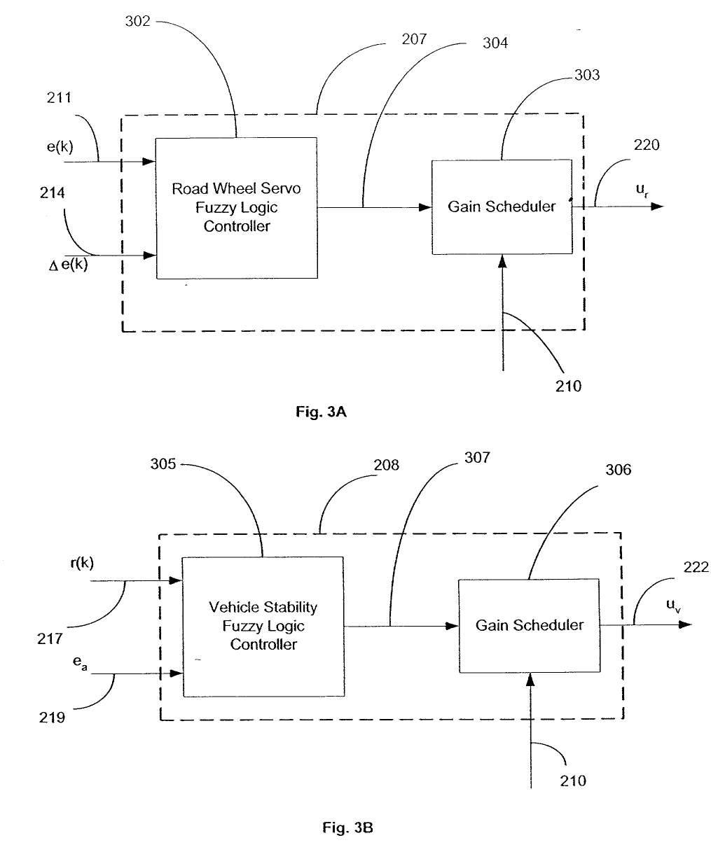

FIG. 3A shows the block diagram of an embodiment for the road wheel servo controller 207 that is used in the fuzzy logic control unit 203. The road wheel servo controller 207 includes a fuzzy logic controller 302 and a gain scheduler 303. The inputs to the fuzzy logic controller 302 are the road wheel angle error signal (e(k)) 211 and the error change signal (Δe(k)) 214. The fuzzy logic controller output (uᵣ(k)) 304 is the input to the gain scheduler 303. The output of the gain scheduler 303 is the road wheel servo controller output value (uᵣ) 220. The fuzzy logic controller output (uᵣ(k)) 304 is generated using the following dynamic equation:

uᵣ(k)=uᵣ(k−1)+F[e(k),Δe(k)] (1),

where Δuᵣ=F[e(k),Δe(k)] is a nonlinear mapping which is implemented by using a fuzzy logic strategy. The vehicle speed signal (v(k)) 210 is used as a scheduling signal in the gain scheduler 303 that will be described further below.

FIG. 3B shows the block diagram of an embodiment for the vehicle stability controller 208 that is used in the fuzzy logic control unit 203. The vehicle stability controller 208 includes a fuzzy logic controller 305 and a gain scheduler 306. The inputs to the fuzzy logic controller 305 are the acceleration error signal (eₐ(k)) 219 and the yaw rate signal (r(k)) 217. The fuzzy logic controller output (uᵥ(k) ) 305 is the input to the gain scheduler 306. The output of the gain scheduler 306 is the vehicle stability control value (uᵥ) 222. The fuzzy logic controller output (uᵥ(k)) 305 is generated using the following dynamic equation:

uᵥ(k)=uᵥ(k−1)+F[eₐ(k),r(k)] (2),

where Δuᵥ=F[eₐ(k),r(k)] is a nonlinear mapping which is implemented by using a fuzzy logic strategy. The vehicle speed signal (v(k)) 210 is used as the scheduling signal in the gain scheduler 306 that will be described further below.

As shown in FIG. 2, the output control values (uᵣ) 220 and (uᵥ) 222 are added together by summing junction 223 producing output signal u(k) 224. Output signal u(k) 224 is then presented to summing junction 225 where the output signal of the rate feedback compensator 226 is subtracted and the resulting signal is then presented as an input to motor drive 221. An output signal from motor drive 221 is presented to summing junction 205 of the controlled plant 202. The rate feedback compensator 227 receives as input a road wheel rate (ωᵣ) 209 that is generated by derivative operation for the road wheel angle signal (θᵣ(k)) 213.

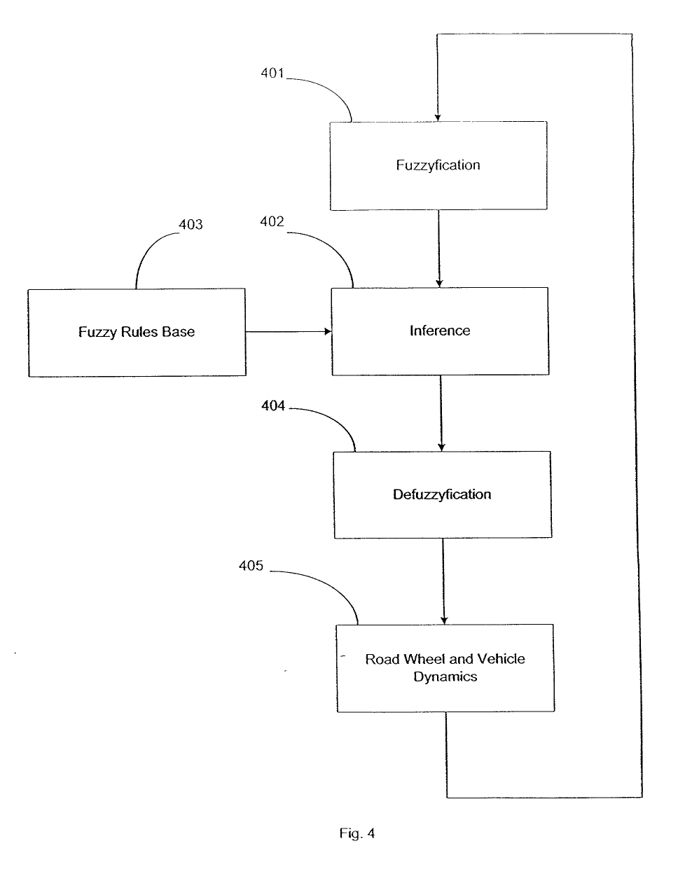

The realization of the control functions uᵣ and uᵥ in equations (1) and (2) are based on a fuzzy logic strategy and includes three stages: fuzzification, inference, and defuzzification. The flowchart for the road wheel fuzzy logic control system 200 is given in FIG. 4.

As shown in FIG. 4, the first task of the fuzzy logic controllers 302, 305, as shown in FIG. 3, is the translation of numerical input variables to linguistic variables that will further be used. Labeling a crisp value of a numerical input variable with a linguistic term and determining the corresponding grade of membership is called fuzzification. In other words, fuzzification is a process of converting a crisp input value to a fuzzy value in certain input universes of discourse. A membership function (MF) is a curve that defines how each point in the input space is mapped to a membership value (or degree of membership) between 0 and 1.

The fuzzification process 401 transforms the input and output variables of fuzzy logic control unit 203 into the setting of linguistic variables which may be viewed as labels of a fuzzy set and determine the corresponding grade of membership. These input and output variables include e(k)211, Δe(k)214, uᵣ(k) 304 for the road wheel servo controller 207, and eₐ(k)219, r(k)217 uᵥ(k) 307 for the vehicle stability controller 208. For the sake of simplicity, the triangular-shaped membership functions of these fuzzy sets for all above variables are chosen and shown in FIG. 5. Each membership function is a map from the values given in the horizontal axis with a certain operable range (universe of discourse) to the interval [0,1], which is the degree of membership. The following gives a brief explanation for FIG. 5.

In FIG. 5, seven triangular-shaped curves are defined to cover the required range of an input value, or universe of discourse in the fuzzy logic terms. In order to label a crisp value of a numerical input variable with a linguistic term, we use N to represent negative, P positive, ZE approximately zero, S small, M medium, and L large. Thus, A fuzzy set is defined (or is labeled) for each variable with the linguistic terms as follows:

NL: negative large

NM: negative medium

NS: negative small

ZE: approximately zero

PS: positive small

PM: positive medium

PL: positive large

This fuzzy set is also written as follows:

L={NL,NM,NS,ZE,PS,PM,PL}

The symbol l is used to represent any one of NL, NM, NS, ZE, PS, PM, PL for each input or output variable. That is lεL.

Using μₓ to represent the membership function where x is one of the input or output variables, then, Table 1 lists all input/output variables and their membership function names. The membership functions of the road wheel servo fuzzy logic controller 207 and the vehicle stability fuzzy logic controller 208 are expressed in FIG. 5.

TABLE 1
Fuzzy variables and their membership function names

| Input/output | Input/output variable x | Membership function μₓ |
|---|---|---|
| Input | e (Road wheel angle error) | μₑ |
| Input | Δe (Road wheel angle error | μ_{Δe} |
| | change) | |
| Output | μᵣ (Road wheel servo control | μᵤ_{ᵣ} |
| | variable) | |
| Input | eₐ (Vehicle lateral acceleration | μₑ_{ₐ} |
| | error) | |
| Input | r (Vehicle yaw rate) | μᵣ |
| Output | uᵥ (Vehicle stability control | μᵤ_{ᵥ} |
| | variable) | |

In a preferred embodiment, multiple membership functions given in Table 1 are expressed in FIG. 5. Each of these membership functions has the same shape. However, as the variable x cycles through the membership functions listed in table 1, the number of triangular-shaped curves and their placement (points in the horizontal axis, p₁, p₂ . . . , p₇) may change. The equations for the membership functions in Table 1 and FIG. 5 may be expressed as follows

μₑ={μ_{NL}(e),μ_{NM}(e),μ_{NS}(e),μ_{ZE}(e),μ_{PS}(e),μ_{PM}(e),μ_{PL}(e)}

μ_{Δe}={μ_{NL}(Δe),μ_{NM}(Δe),μ_{NS}(Δe),μ_{ZE}(Δe),μ_{PS}(Δe),μ_{PM} (Δe),μ_{PL}(Δe)}

μᵤ_{ᵣ}={μ_{NL}(uᵣ),μ_{NM}(uᵣ),μ_{NS}(uᵣ)μ_{ZE}(uᵣ),μ_{PS}(uᵣ)μ_{PM}(uᵣ),μ_{PL}(uᵣ)}

μₑ_{ₐ}={μ_{NL}(eₐ),μ_{NM}(eₐ),μ_{NS}(eₐ),μ_{ZE}(eₐ),μ_{PS}(eₐ),μ_{PM}(eₐ),μ_{PL}(eₐ)}

μᵣ={μ_{NL}(r),μ_{NM}(r),μ_{NS}(r),μ_{ZE}(r),μ_{PS}(r),μ_{PM}(e),μ_{PL}(r)}

μᵤ_{ᵥ}={μ_{NL}(uᵥ),μ_{NM}(uᵥ),μ_{NS}(uᵥ),μ_{ZE}(uᵥ),μ_{PS}(uᵥ),μ_{PM}(uᵥ),μ_{PL}(uᵥ)}

Thus, the general form of a membership function for the variable x is given by:

μₓ={μ_{NL}(x),μ_{NM}(x),μ_{NS}(x),μ_{ZE}(x),μ_{PS}(x)μ_{PM}(x),μ_{PL}(x)}

Where μₗ(x), (lεL) denotes each membership of membership function μₓ for each given variable x.

FIG. 5 shows membership functions for all variables in one common universe of discourse which is called a normalized universe of discourse. All numerically crisp input variables, e(k)211, Δe(k)214, eₐ(k)219, and r(k)217, would be normalized. Normalization performs a scale transformation. It maps the crisp values of input variables into a normalized universe of discourse. It also maps the normalized value of control output variable uᵣ 304, uᵥ 307 onto its physical domain. The normalization for all variables is obtained by dividing each crisp input by the upper boundary value (maximum deviation in the whole measuring range) for the associated universe. Thus, a normalized universe of discourse is given in FIG. 5 for all variables. As an example, the input range of road wheel angle error e(k) 211 is in [−10, 10], and its upper boundary is 10. As a result, the normalized universe of discourse is obtained by dividing by 10.

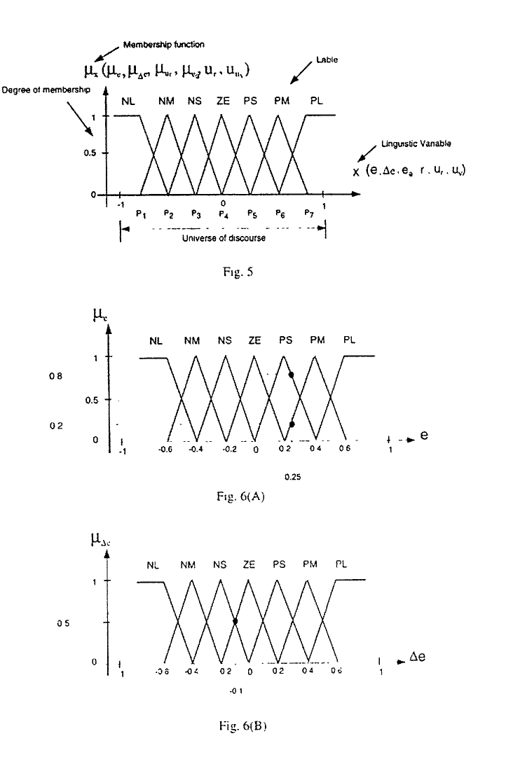

As an example, consider the membership function μₑ of the road wheel error variable e shown in FIG. 6(A). If the normalized road wheel error e=0.25 in a certain instant sampling time, the degree of membership function for each member μₑ is: μ_{NL}(e)=0, μ_{NM}(e)=0, μ_{NS}(e)=0, μ_{ZE}(e)=0, μ_{PS}(e)=0.8, μ_{PM}(e)=0.2, and μ_{PL}(e)=0. The normalized road wheel error may also be described as μₑ(0.2)={0, 0, 0, 0, 0.8, 0.2, 0}. This equation can be interpreted to mean that the variable e=0.2 belongs to “positive small” at 80%, belongs to “positive medium” at 20%, and belongs to other categories at 0%. Thus, the crisp input variable e(k) can be fuzzified to obtain its membership values through the associated seven triangle-shaped curves in the normalized universe of discourse.

At the same given sampling time, suppose the normalized road wheel error change Δe(k)=−0.1 (see FIG. 6(B)). The degree of membership function for each member of μ_{Δe} is: μ_{NL}(Δe)=0, μ_{NM}(Δe)=0, μ_{NS}(Δe)=0.5, μ_{ZE}(Δe)=0.5, μ_{PS}(e)=0, μ_{PM}(e)=0, and μ_{PL}(e)=0.

Thus, for each linguistic variable lεL, their membership functions of the input variables e(k)211 and Δe(k)214 for the road wheel servo controller 302 are μₗ(e) and μₗ(Δe). At each discrete point of the universe of discourse, the values of μₗ(e) and μₗ(Δe), which are degrees of membership functions, are determined. They are expressed by the value μₗ(e(k)) and μₗ(Δe(k)), such as μ_{PS}(0.25)=0.8 for e(k) and μ_{ZE}(−0.1)=0.5 for Δe(k) in the above example.

A similar description would apply for the membership function μₗ(eₐ) and μₗ(r) of the input variable eₐ(k) 219 and r(k) 217 for the vehicle stability controller 305. At each discrete point of the universe of discourse, the values of μₗ(e) and μₗ(Δe) are expressed by μₗ(eₐ(k)) and μₗ(r(k)).

Thus, the fuzzification step 401 converts all crisp values of input variables e(k)211, Δe(k)214, eₐ(k)219, r(k)217 to fuzzy values by determining the corresponding grade of membership. Each value, μₗ(e(k)), μₗ(Δe(k)) and μₗ(eₐ(k)), μₗ(r(k)), will be used in the inference (fuzzy logic decision process) 402.

The determination of conclusions or the generation of hypotheses based on a given input state is called inference. The inference component 402 mainly imitates the human operator strategies. Associated with the inference 402, which is known as the fuzzy logic decision process, is a set of fuzzy rules 403. A typical fuzzy logic control unit contains a number of IF-THEN type inference rules, where the IF part is called the “antecedent” and the THEN part is called the “consequent”.

In practical applications, the fuzzy rule sets usually have several antecedents that are combined using fuzzy operators, such as AND. The AND operation uses the minimum value of all the antecedents.

As an example for the road wheel servo controller 302, now suppose the error e=0.25 and error change Δe=−0.1 at a given sampling time (shown in FIG. 6(A) and FIG. 6(B)). One of the fuzzy logic rules is given as follows: “If the error e is PS and the error change Δe is ZE, then output uᵣ is PS.”

This rule is related with the member PS for the error e and member ZE for the error change Δe. From FIG. 6(A) and FIG. 6(B), μ_{PS}(0.25)=0.8 for e and μ_{ZE}(−0.1)=0.5 for Δe. Because it is an AND operation in the above rule, the minimum criterion is used and the output value is 0.5. That is,

μ_{PS}(e) AND μ_{ZE}(Δe )=min(μ_{PS}(eₗ),μ_{ZE}(Δe ₗ))=min(0.8,0.5)=0.5

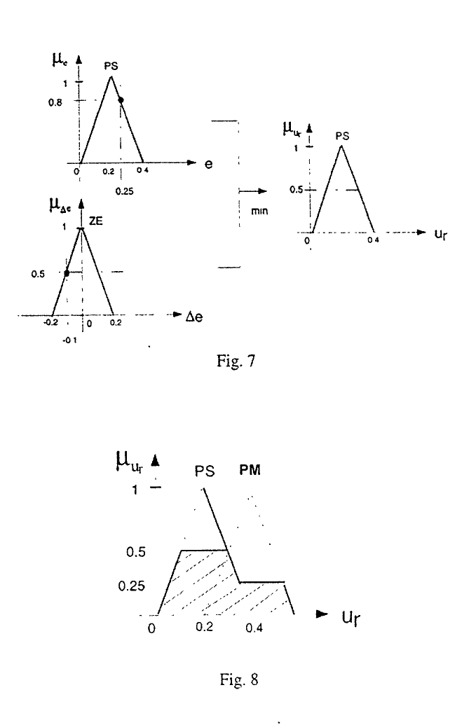

FIG. 7 provides the illustration for this operation.

This result is combined with the results of other rules to finally generate the fuzzy output value. Because several rules are triggered at every sampling time, each rule produces its own result like above example. The result for each rule must be combined or inferred before generating a crisp output.

There are several different ways to define the result of a rule. One of the most common inference strategies is the MAX-MIN inference method which cuts the output's membership function at the top. The horizontal coordinate of a “fuzzy centroid” of the area under that function is taken as the output. This method does not combine the effects of all applicable rules but does produce a continuous output function and is easy to implement.

Consider the example, four rules are fired when the error e=0.25 and error change Δe=−0.1 at a given sampling time. They are given as follows:

Rule 1: “If the error e is PS and the error change Δe is ZE, then output uᵣ is PS”

Rule 2: “If the error e is PS and the error change Δe is NS, then output uᵣ is PS”

Rule 3: “If the error e is PM and the error change Δe is ZE, then output uᵣ is PM”

Rule 4: “If the error e is PM and the error change Δe is NS, then output uᵣ is PM”

Then, outputs and degrees of membership functions from above rules are:

Rule 1: μ_{PS}(uᵣ): min(μ_{PS}(eₗ),μ_{ZE}(Δeₗ))=min (0.8,0.5)=0.5

Output1=0.5

Rule 2: μ_{PS}(uᵣ): min(μ_{PS}(eₗ),μ_{NZ}(Δeₗ))=min (0.8,0.5)=0.5

Output2=0.5

Rule 3: μ_{PM}(uᵣ): min(μ_{PM}(eₗ),μ_{ZE}(Δeₗ))=min (0.25,0.5)=0.25

Output3=0.25

Rule 4: μ_{PM}(uᵣ): min(μ_{PM}(eₗ),μ_{NZE}(Δeₗ))=min (0.25,0.5)=0.25

Output4=0.25

Four results from the above four overlapped rules yield an overall result as shown in FIG. 8.

All rules of the fuzzy logic controllers 302 and 305 are given in Table 2 and Table 3, respectively. The input variables and their labels are laid out along the axes, and labels of output variable are inside the table. In Table 2, the rules are written in the form: “If the error e is lₑ and error change Δe is l_{Δe}, then output Δuᵣ is lᵤ_{ᵣ}”, where lₑ,l_{Δe},lᵤ_{ᵣ}εL. In the table, each Ri(i=1,2 . . . , 49) represents one of labels, that is one of NL, NM, NS, ZE, PS, PM, or PL. In Table 3, the rules are written in the form: “If the lateral acceleration error eₐ is lₑ_{ₐ} and yaw rate r is lᵣ, then output Δuᵥ is lᵤ_{ᵥ}”, where lₑ,l_{Δe},lᵤ_{ᵣ}εL. In the table, each Qi(i=1,2 . . . ,49) represents one of the labels (NL, NM, NS, ZE, PS, PM, PL). Each Ri and Qi in Table 2 and Table 3 can be determined according to the system and control engineering experiences of designer.

Table 2 and Table 3 contain forty-nine rules respectively. In practice, the tables have some empty cells, indicating that those cells have no possibility of occurring in the real system.

The rules can be solved in parallel in hardware or sequentially in software.

TABLE 2
Road wheel angle error e

| | | | | | | |
|---|---|---|---|---|---|---|
| NL | NM | NS | ZE | PS | PM | PL |

Road wheel angle error change Δe

| | | | | | | | |
|---|---|---|---|---|---|---|---|
| NL | R1 | R2 | R3 | R4 | R5 | R6 | R7 |
| NM | R8 | R9 | R10 | R11 | R12 | R13 | R14 |
| NS | R15 | R16 | R17 | R18 | R19 | R20 | R21 |
| ZE | R22 | R23 | R24 | R25 | R26 | R27 | R28 |
| PS | R29 | R30 | R31 | R32 | R33 | R34 | R35 |
| PM | R36 | R37 | R38 | R39 | R40 | R41 | R42 |
| PL | R43 | R44 | R45 | R46 | R47 | R48 | R49 |

TABLE 3
Vehicle lateral acceleration error eₐ

| | | | | | | |
|---|---|---|---|---|---|---|
| NL | NM | NS | ZE | PS | PM | PL |

Vehicle yaw rate r

| | | | | | | | |
|---|---|---|---|---|---|---|---|
| NL | Q1 | Q2 | Q3 | Q4 | Q5 | Q6 | Q7 |
| NM | Q8 | Q9 | Q10 | Q11 | Q12 | Q13 | Q14 |
| NS | Q15 | Q16 | Q17 | Q18 | Q19 | Q20 | Q21 |
| ZE | Q22 | Q23 | Q24 | Q25 | Q26 | Q27 | Q28 |
| PS | Q29 | Q30 | Q31 | Q32 | Q33 | Q34 | Q35 |
| PM | Q36 | Q37 | Q38 | Q39 | Q40 | Q41 | Q42 |
| PL | Q43 | Q44 | Q45 | Q46 | Q47 | Q48 | Q49 |

The symbolic control action cannot be used for a real world road wheel controlled plant, so the linguistically output variables have to be defuzzyfied. Defuzzification 404 is the calculation of a crisp numerical value of the fuzzy logic controllers' 302, 305 output based on the symbolic results. Basically, defuzzification 404 is a mapping from a space of fuzzy control actions into a space of non-fuzzy control actions. Thus, the result of the fuzzy set is defuzzified into a crisp control signal.

There are several defuzzification methods. The “centroid” method is very popular in which the “center of mass” of the result provides the crisp value. The result is given as follows:

$${u}_{x} = \frac{{\sum }_{i = 1}^{n} {μ}_{l} ( {x}_{i} ) {x}_{i}}{{\sum }_{i = 1}^{n} {μ}_{l} ( {x}_{i} )} \qquad ( 3 )$$

where xₗ is a running point in a discrete universe, μₗ(xₗ) is its membership value in the membership function, and n is the number of rules.

In the embodiments of FIGS. 2, 3A and 3B, the results of all the rules are defuzzified to a crisp value by using the centroid defuzzification method. According to (3), a crisp output value for the road wheel controller is

$${u}_{r} = \frac{{\sum }_{i = 1}^{n} {μ}_{l} ( {u}_{ri} ) {u}_{ri}}{{\sum }_{i = 1}^{n} {μ}_{l} ( {u}_{ri} )} ,$$

and a crisp output value for the road wheel controller is

$${u}_{v} = \frac{{\sum }_{i = 1}^{n} {μ}_{l} ( {u}_{vi} ) {u}_{vi}}{{\sum }_{i = 1}^{n} {μ}_{l} ( {u}_{vi} )} .$$

In the above example, the centroid computation yields.

$$\begin{matrix}{u}_{r} = \frac{{μ}_{l} ( {u}_{r1} ) {u}_{r1} + {μ}_{l} ( {u}_{r2} ) {u}_{r2} + {μ}_{l} ( {u}_{r2} ) {u}_{r2} + {μ}_{l} ( {u}_{r2} ) {u}_{r2}}{{μ}_{l} ( {u}_{r1} ) + {μ}_{l} ( {u}_{r2} ) + {μ}_{l} ( {u}_{r3} ) + {μ}_{l} ( {u}_{r4} )} \\ = \frac{( 0.5 \times 0.5 ) + ( 0.5 \times 0.5 ) + ( 0.25 \times 0.25 ) + ( 0.25 \times 0.25 )}{0.5 + 0.5 + 0.25 + 0.25} = 0.5\end{matrix}$$

This is the final control output value in the given sampling time.

The actual fuzzy logic control laws are defined by the equations (1) and (2). The closed control system can be checked to see if it satisfies the performance requirement and then decide what should be done in the next steps. If the control quality is sufficient, the design procedure terminates at this stage. Otherwise, there exist three different possibilities for an iterative controller improvement:

Prepare a new practical test for an improvement of the process model;

Modify the membership functions; and

Modify the rule base.

In summary, the procedure of fuzzy logic controller operation includes three elements, or three stages: an input stage, a processing stage, and an output stage. The input stage maps sensor inputs to the appropriate membership functions; the processing stage invokes each appropriate rule and generates a result for each, then combines the results of the rules; and finally the output stage converts the combined result back into a specific control output value.

The road wheel system dynamics change with the road wheel actuator and its assembly, vehicle dynamics, road condition et al. In particular, the gain of the vehicle dynamics changes with the vehicle speed. A gain scheduling strategy is an effective way of controlling systems whose dynamics change with the operating conditions. Such a strategy is normally used in the control of nonlinear plants where the relationship between the plant dynamics and operating condition is known.

In FIG. 3A and FIG. 3B, the gain schedulers 303, 306 are used to provide gain scheduling by using the vehicle speed signal v(k)210. In general, the output signals of the gain schedulers 303, 306 will equal the signal u(k) 224 plus an offset value with the offset values being a function of speed.

Another way to realize the gain scheduling is to add directly the vehicle speed signal v(k)210 as a third input signal for the above two fuzzy logic control laws. But with this approach the operating time and rules will be increased.

By using this gain scheduling fuzzy logic feedback control strategy, the resultant vehicle road wheel control system 200 has the adaptive capability to overcome the uncertainties of the road wheel system and vehicle dynamics.

To design a control system using the conventional model based methods, it is necessary to establish a nominal plant model as accurate as possible in each operating point. However, this is impossible to achieve due to the complicated dynamics and severe non-linearity of the road wheel system with the effects of vehicle dynamics. Because there is no need for an explicit model of the controlled plant in order for a fuzzy logic controller to be designed, the design process for the road wheel control system can be extremely simple.

The above stated fuzzy logic algorithm is realized by using a microprocessor that provides the required computing performance while maintaining a low cost. Any additional hardware investments are not required.

The present invention is intended to cover the concept of using fuzzy logic for the road wheel steering control in multiple applications. For instance, the number of rules may be reduced or increased depending on the operating time of the microprocessors, the cost and any other engineering considerations. The number of the input variables to the fuzzy logic controller 207 and 208 as mentioned above may be increased or reduced based on various requirements. The vehicle speed signal v(k)210 can be one of multiple input signals to the fuzzy logic control unit 203 directly. In this case, the outputs of the fuzzy logic controllers 302, 305 are scheduled directly. The road wheel rate feedback loop using the rate feedback signal ω_{θ}209, in the present invention, is used to improve the system's damping property. However, this loop is not a necessary choice as several other realizations are also possible.

The foregoing detailed description is merely illustrative of several physical embodiments of the invention. Physical variations of the invention, not fully described in the specification, may be encompassed within the purview of the claims. Accordingly, any narrower description of the elements in the specification should be used for general guidance, rather than to unduly restrict any broader descriptions of the elements in the following claims.

We claim:

1. A road wheel fuzzy logic control system for an automotive vehicle, comprising:
a fuzzy logic control unit receiving, a plurality of input signals, and generating a control output signal; and
a road wheel subsystem receiving said control output signal and generating an output feedback signal to said fuzzy logic control unit;
wherein said fuzzy logic control unit tracks an input signal under the effects of uncertainty and disturbance from said road wheel subsystem and vehicle dynamics and controls said effects of said uncertainty and disturbance and provides vehicle stability control.

2. The road wheel fuzzy logic control system of claim 1, wherein said road wheel subsystem, comprises:
a motor drive receiving as input a second control output signal and generating a motor drive output signal;
said second control output signal comprising the sum of said control output signal and a second control input signal; and
a controlled plant receiving said second control output signal and generating a road wheel rate signal and a road wheel angle signal.

3. The road wheel fuzzy logic control system of claim 1, wherein said fuzzy logic control unit uses a fuzzy logic strategy to control said uncertainty and disturbance.

4. The road wheel fuzzy logic control system of claim 1, wherein said input signal comprises a reference angle input signal.

5. The road wheel fuzzy logic control system of claim 2, wherein said controlled plant comprises:
vehicle dynamics sensor array for sensing a dynamic variable of said road wheel subsystem;
said vehicle dynamics sensor array receiving said road wheel angle signal and generating a vehicle control output signal; and
an actuator-based road wheel dynamics receiving a vehicle control input signal and generating said road wheel angle signal and said road wheel rate signal;
wherein said vehicle control input signal is the sum of said vehicle control output signal and said motor drive output signal.

6. The road wheel fuzzy logic control system of claim 5, wherein said dynamic variable comprises a yaw rate signal.

7. The road wheel fuzzy logic control system of claim 5, wherein said dynamic variable comprises a vehicle speed signal.

8. The road wheel fuzzy logic control system of claim 5, wherein said dynamic variable comprises a lateral acceleration signal.

9. The road wheel fuzzy logic control system of claim 2, wherein said road wheel subsystem further comprises a rate feedback compensator;
said rate feedback compensator receiving as input said road wheel rate signal and generating said second control input signal.

10. The road wheel fuzzy logic control system of claim 2, wherein said fuzzy logic controller further comprises a vehicle stability control unit and a road wheel control unit;
said vehicle stability control unit receiving as input said dynamic variable and generating a vehicle stability control output signal; and
said road wheel control unit receiving as inputs an error signal and an error change signal and generating a road wheel control output signal.

11. The road wheel fuzzy logic control system of claim 10, wherein said control output signal is the sum of said vehicle stability control output signal and said road wheel control output signal.

12. The road wheel fuzzy logic control system of claim 10 further comprising an error calculator and an error change calculator;
said error calculator receiving as inputs said dynamic variable;
said error calculator generating said acceleration error input signal to said vehicle stability control unit;
said error change calculator receiving as input said error signal and providing said error change signal to said road wheel control unit;
wherein said error signal is equal to the difference between said road wheel angle reference signal and said road wheel angle signal.

13. The road wheel fuzzy logic control system of claim 10, wherein said vehicle stability control unit comprises a fuzzy logic controller and a gain scheduler;
said fuzzy logic controller receiving as input said dynamic variable and generating a first output signal; and
said gain scheduler receiving as inputs said first output signal from said fuzzy logic controller and said vehicle speed signal and generating said first control output signal.

14. The road wheel fuzzy logic control system of claim 13, wherein said road wheel control unit comprises a second fuzzy logic controller and a second gain scheduler;
said second fuzzy logic controller receiving as inputs said error signal and said change error signal and generating a second output signal; and
said second gain scheduler receiving as inputs said second output signal from said second fuzzy logic controller and said vehicle speed signal and generating said second control output signal.

15. A method of implementing a fuzzy logic strategy for a fuzzy logic control system used in a road wheel control system, comprising:
generating a linguistic variable from a numerical input variable of a road wheel system;
generating a hypothesis based on said linguistic variable and a fuzzy rule;
generating a numerical output value from said hypothesis to control said road wheel system; and
generating said numerical input variable by applying said numerical output value to a road wheel and a vehicle dynamic signal.

16. The method of claim 15, wherein said vehicle dynamic signal comprises a yaw rate signal.

17. The method of claim 15, wherein said vehicle dynamic signal comprises a vehicle speed signal.

18. The method of claim 14, wherein said vehicle dynamic signal comprises a lateral acceleration signal.
